(19) United States
(12) Patent Application Publication
(10) Pub. No.: US 2003/0134704 A1
(43) Pub. Date: Jul. 17, 2003

(54) Sliding contact guide for transmission device

(76) Inventors: Masahiko Konno, Osaka (JP); Hiroshi Horie, Osaka (JP)

Correspondence Address: HOWSON AND HOWSON, ONE SPRING HOUSE CORPORATION CENTER, BOX 457, 321 NORRISTOWN ROAD, SPRING HOUSE, PA, 19477, US

(21) Appl. No.: 10/334,250

(22) Filed: Dec. 30, 2002

(30) Foreign Application Priority Data
Jan. 17, 2002 (JP) 009114/2002

(51) Int. Cl. F16H 7/08; F16H 7/18

(52) U.S. Cl. 474/111; 474/140

(57) ABSTRACT

A sliding contact guide for a transmission chain or belt comprises a synthetic resin shoe having an integrally molded, slotted plate-receiver for receiving a metal reinforcing plate, or alternatively a reinforcing base to which a shoe is attached by clips molded as parts of the shoe. In the guide having the metal reinforcing plate, gaps between the plate and the slot are filled with a buffer material. In the guide comprising a shoe clipped to a reinforcing base, a gap between the shoe and the base is filled with a buffer material. The buffer material prevents relative wobbling between the guide components, and increases manufacturing tolerances, thereby suppressing impact noise and also reducing production cost.

### FIELD OF THE INVENTION

This invention relates to a sliding contact guide for use-in a chain transmission which transmits power from a driving sprocket to a driven sprocket, or in a belt transmission which transmits power from a driving pulley to a driven pulley.

### BACKGROUND OF THE INVENTION

In general, in a chain or belt transmission such as the valve timing transmission in an internal combustion engine, a pivoted sliding contact guide may be used as a tensioner, and a fixed sliding contact guide may be used simply as a guide. These movable and fixed guides are typically attached to the body of an engine or other mechanism by a mounting bolt, pin or the like, and prevent vertical and transverse vibrations of the chain or belt, or both prevent such vibrations and maintain suitable tension in the chain or belt.

An example of a conventional sliding contact guide is the movable guide described in Japanese patent application No. 322380/2001. This guide 500, shown in FIGS. 4 and 5, comprises a synthetic resin guide body 510 including an elongated shoe 511, on a front surface of which a traveling chain slides, and a vertical plate-receiving portion 512, provided on a back surface of the shoe. The plate-receiving portion extends longitudinally along the guide and has a slot 512a with a longitudinally extending opening facing away from the shoe. A metallic reinforcing plate 520 fits into the slot 512a. Conventional sliding contact guides also include the movable guides 600, shown in FIGS. 6 and 7 and described in Japanese patent application No. Hei. 11-155672. Each of these guides has a synthetic resin shoe 610 on the surface of which a transmitting medium such as a chain, a belt or the like slides. Each guide also has a reinforcing base 620, on which the back surface of the synthetic resin shoe is supported.

In the guide 500, shown in FIG. 4, the synthetic resin guide body 510 has a complicated structure, including a shoe 511, on which a chain slides, a slot 512a, a mounting hole 512b, a boss 512c, reinforcing ribs 512d, which reinforce the guide and improve its strength, a tensioner abutting portion 512e, and a tongue 512f, which locks the metallic reinforcing plate 520 in place. In the molding of the conventional movable guide 500, correct sizing of the molded guide body cannot be ensured because thermal expansion and shrinkage in the directions of arrows Y occur in the molding process. Therefore size errors are liable to occur in the radius of curvature of the shoe 511. Accordingly, it is difficult to ensure contact between the metallic reinforcing plate 520 and the bottom of the slot 512a along the entire length of the guide during assembly. Furthermore, as shown in FIG. 5, a mold draft is required. This results in a diverging slot 512a, which is another source of error in the relationship between the guide body and reinforcing plate.

As a result, in the conventional movable guide 500, many gaps exist between the guide body 510 and the reinforcing plate 520, and the regions of mutual contact between the guide body and the reinforcing plate are far smaller than in an ideal guide. The limited contact between the guide body and reinforcing plate caused several problems: low manufacturing yield because numerous guides failed to meet design specifications; impact noises due to wobbling in the Y direction between the guide body 510 and the reinforcing plate 520; and a significant reduction in the useful life of the guide.

The conventional movable guide 600, shown in FIGS. 6 and 7, has a comparatively thin structure in which the synthetic resin shoe 610 includes L-shaped side holding portions 611, distributed in an alternating arrangement along its opposite side edges of the reinforcing base 620, for locking the shoe on the reinforcing base 620. In addition, the shoe has a U-shaped tip hook 612 for engaging the base.

Thermal Shrinkage of the shoe, in the direction of the arrows in FIG. 7, occurs during cooling in the process of molding the shoe. This shrinkage results in a size error in the radius of curvature of the shoe 610, and consequently the radius of curvature is liable to depart from the specified tolerance. Thus, when the shoe is engaged with the reinforcing base during assembly, a space S may appear between the shoe and the base, particularly at the center portion along the longitudinal direction of the guide, as shown in FIG. 7. Consequently one or more of the L-shaped holding portions 611 may not engage properly with the base, or may become disengaged. As in the case of the guide 500, impact noises are generated by wobbling shoe and base relative to each other in the direction H in FIG. 7, and the useful life of the guide is shortened. These problems have been addressed by low rate molding and by use of synthetic resins having low thermal shrinkage. However, low rate molding decreases production efficiency, and synthetic resins having low thermal shrinkage are costly.

Accordingly, among the objects of this invention are to provide a solution to the above-mentioned problems; to provide an inexpensive sliding contact guide that can suppress impact noise due to wobbling of the guide itself; and to increase the tolerance range in molding in order to obtain high production efficiency and low production cost.

### BRIEF SUMMARY OF THE INVENTION

An elongated sliding contact guide for a transmission device, in accordance with a first embodiment of the invention, comprises a guide body including a shoe extending in the longitudinal direction of the guide. The shoe has on one side thereof a surface for sliding contact with a flexible, traveling power transmitting medium such as a chain, a belt, or the like. On the opposite side of the shoe, a plate-receiving portion also extends along the longitudinal direction of the guide. The plate-receiving portion has a slot extending along the longitudinal direction, and defined by interior walls. The slot opens in a direction away from the shoe. The shoe and plate-receiving portion are integrally molded as a unit from a synthetic resin. A reinforcing plate fits into the slot, and a buffer material fills a gap between the reinforcing plate and an interior wall of the slot. In the case where there are plural gaps between the reinforcing plate and interior walls of the slot, each such gap may be filled with a buffer material.

In a second embodiment, the elongated guide comprises a synthetic resin shoe having on one side thereof a surface for sliding contact with a flexible, traveling, power transmitting medium such as a chain, a belt, or the like, and a reinforcing base disposed on the opposite side of the shoe, and extending along the longitudinal direction of the guide. The shoe is connected to, and supported by, the reinforcing base, and a gap between the shoe and the reinforcing base is filled by a buffer material.

The invention is applicable not only to movable guides which control tension in a power transmitting medium, but also to fixed guides; which are provided primarily to suppress vibration.

The buffer materials can be any of various materials capable of absorbing impact. For example, an elastic member such as a rubber sheet, a sponge sheet, a cotton cloth or the like may be used. Similarly, an adhesive such as epoxy resin, a filler such as a liquid gasket, and a foam resin or the like may be used.

Further, the materials of which the guide body and the synthetic resin shoe are composed are not significantly limited. However, resins such as nylon 6, nylon 66, and nylon 46, aromatic nylons and the like, all known as engineering plastics are preferably used. If exceptionally high strength is required, fiber-reinforced plastics are preferably used.

The materials of which the reinforcing plate or the reinforcing base are composed are likewise not significantly limited. However, iron-bases metals, non-ferrous metals such as aluminum, magnesium, titanium and the like, engineering plastics, fiber-reinforced plastics and the like, all having superior bending rigidity and strength, are preferable.

The buffer material filling the gaps between a slot and a reinforcing plate, or between a synthetic resin shoe and a reinforcing base, eliminates relative wobbling of the guide components, and suppresses impact noises. The buffer material makes molding accuracy less critical, improving production efficiency and reducing production costs. An inexpensive synthetic resin material, which is liable to cool unevenly and subject to significant thermal shrinkage, can be used without detrimental effect.

### BRIEF DESCRIPTION OF THE DRAWINGS

FIG. 1 is an exploded perspective view of movable guide according to a first embodiment of the invention;

FIG. 2 is a cross-sectional view taken on plane A-A in FIG. 1;

FIG. 3 is a schematic elevational view of a movable guide according to a second embodiment of the invention;

FIG. 4 is an elevational view of a conventional movable guide, illustrating the strain due to thermal shrinkage of the guide body;

FIG. 5 is an cross-sectional view of the conventional movable guide of FIG. 4, illustrating the mold draft;

FIG. 6 is an exploded view of an ideal, conventional movable guide of the kind in which the shoe is a separate element fitted to a guide body; and

FIG. 7 is an exploded view of a conventional movable guide of the type shown in FIG. 6, illustrating of the strain due to thermal shrinkage experienced in practice.

### DETAILED DESCRIPTION OF THE PREFERRED EMBODIMENTS

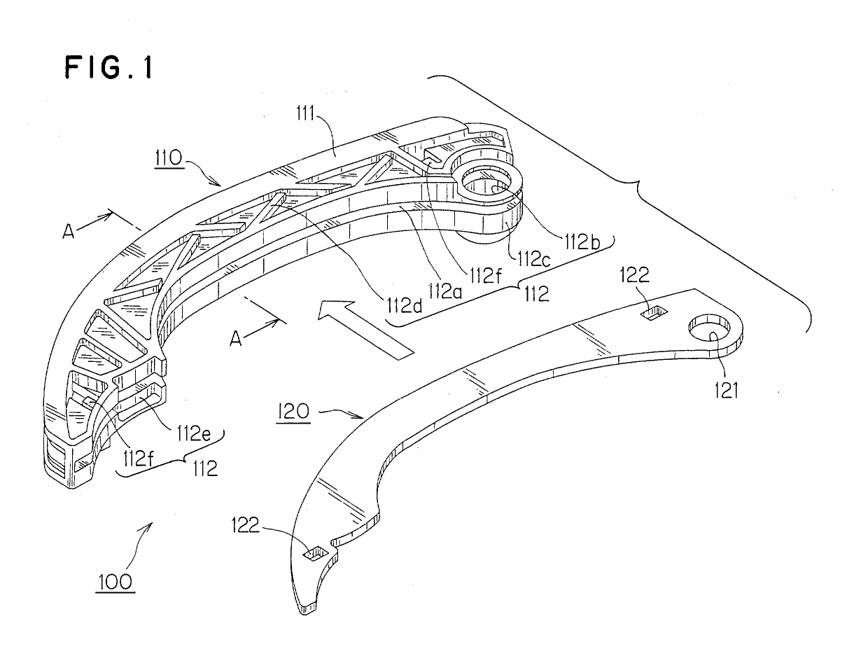

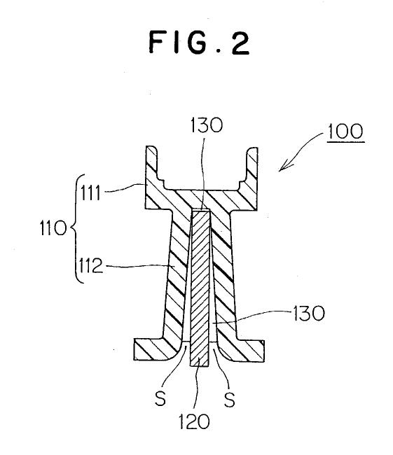

The sliding contact guide 100, shown in FIGS. 1 and 2, is designed to serve as a tensioner lever for applying appropriate tension to a circulating chain transmitting rotation from a drive sprocket to one or more driven sprockets in an internal combustion engine or other machine. The guide is designed for pivoting movement about a mounting shaft (not shown).

The guide 100 is a two-piece structure comprising an integrally molded synthetic resin guide body 110 and a metallic reinforcing plate 120 punched from a steel sheet. The guide is reinforced by incorporating the reinforcing plate 120 into the guide body 110.

The guide body 110 comprises a shoe 111 having a surface on which a chain slides, and a plate-receiving portion 112 extending longitudinally along the shoe and perpendicularly from the side of the shoe opposite the chain-contacting side. The plate-receiving portion has a slot 112a which opens in a direction facing away from the shoe, a boss 112c having a hole 112b for mounting the guide on a shaft (not shown) extending from a frame of an engine or other machine. The guide body has a plurality of reinforcing ribs 112d, which reinforce the guide body structure. The guide body also has a tensioner-contacting portion 112e, which is engageable with the plunger of a tensioner (not shown) so that the tensioner can maintain tension in the chain by controlling the position of the lever about its pivot axis. Tongues 112f are provided to engage locking holes 122 in the reinforcing plate 120 lock the reinforcing plate into the slot of the guide body.

The reinforcing plate 120 includes a hole 121, which is in register with the mounting hole 112b of the guide body 110 when the reinforcing plate is located in slot 112a. Both holes 121 and 112b receive a mounting shaft. When the assembly consisting of the guide body and reinforcing plate is mounted, the reinforcing plate is held in the guide body both by the engagement of tongues 112f with locking holes 122, and by the engagement of holes 121 and 112b with a common mounting shaft. and fitted and positioned, locking holes 122 for locking the tongues 112f of the guide body 110.

In accordance with the invention, as shown in FIG. 2, when the reinforcing plate 120 is fitted into the guide body 110, a buffer material, consisting of a foaming resin, fills the gaps S between the side and bottom walls of the slot 112a of the guide body 110, and the sides and one edge of the reinforcing plate 120. This buffer material 130 avoids wobbling between the guide body 110 and the reinforcing plate 120 due to the gap S.

Although in the embodiment described above, a foaming resin was used as the buffer material 130, various other materials may be used in place of the foaming resin. For example, an elastic sheet such as a rubber sheet, a sponge sheet, a cotton cloth or the like, an adhesive such as epoxy resin or the like, or a filler such as a liquid gasket or the like, may be used.

Vibrations both in, and transverse to, the plane of chain travel are suppressed so that stable travel of the chain is ensured. Moreover, the synthetic resin guide can be made with improved rigidity against bending and improved guide strength, comparable to the rigidity and strength of a conventional aluminum die cast movable guide.

With the buffer material 130 filling the gaps S between the slot 112a and the reinforcing plate 120, wobbling due to the gaps S is avoided, and impact noises are suppressed. At the same time, the use of the buffer material increases the range of manufacturing tolerance of the guide body and reinforcing plate, thereby reducing production cost. Moreover, an inexpensive synthetic resin, subject to uneven cooling and significant thermal shrinkage, can be used so that the use of the buffer material adds very little to the manufacturing cost of the guide.

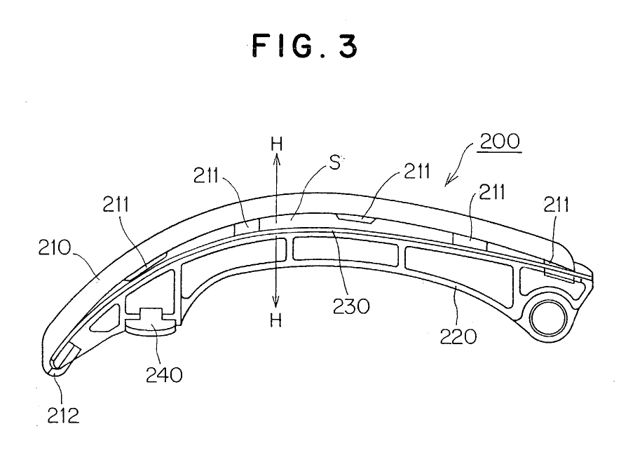

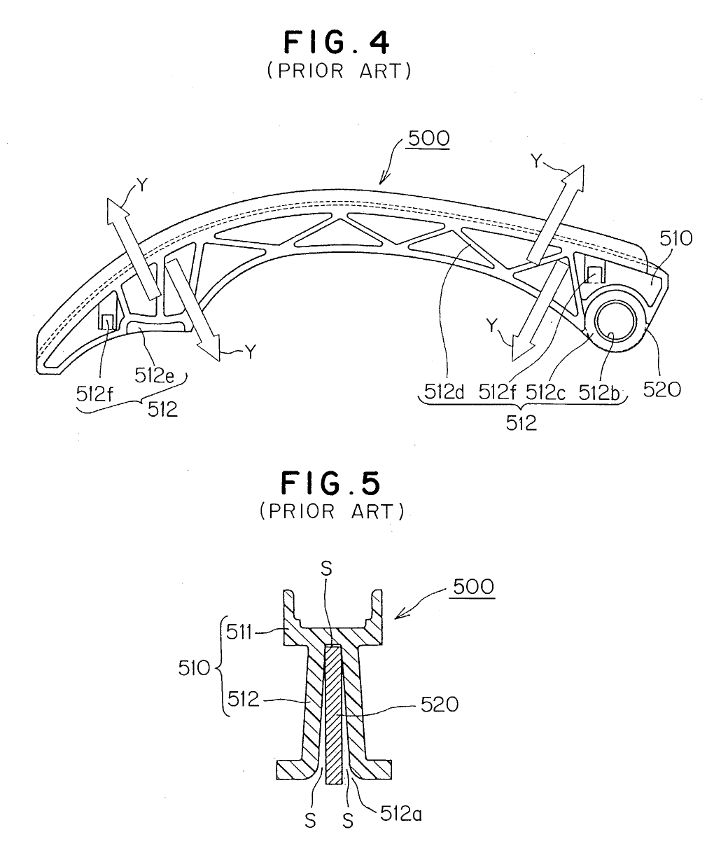

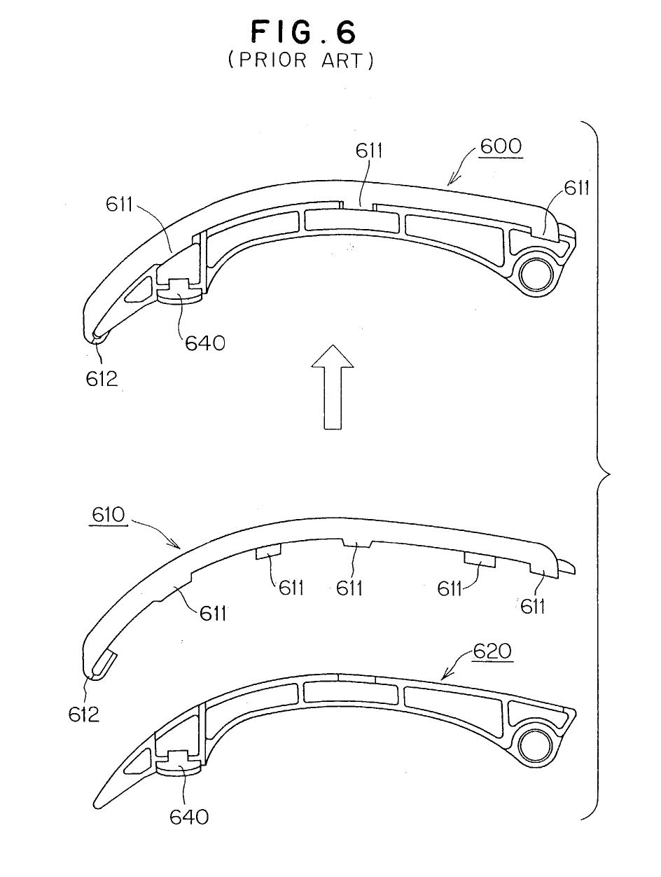

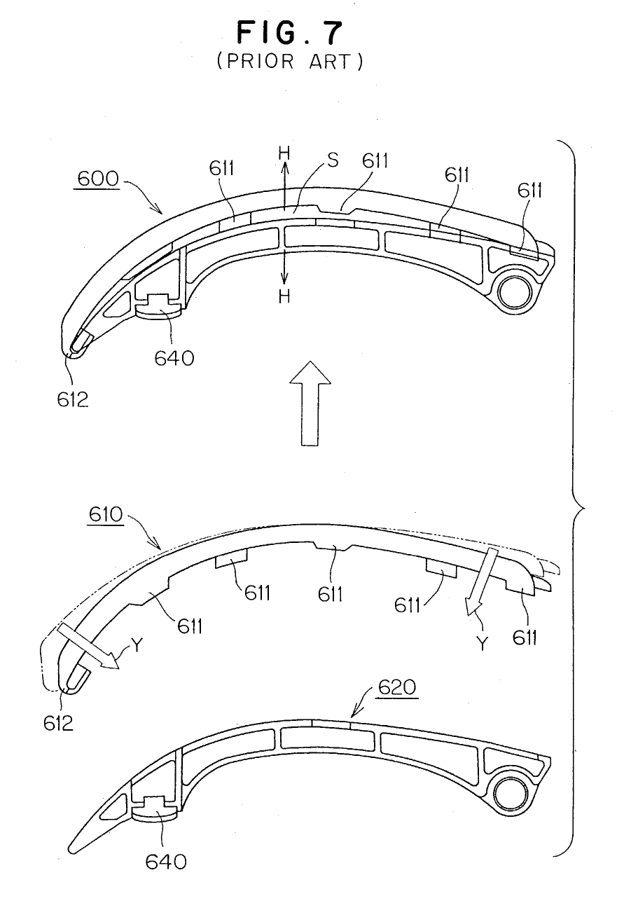

In the second embodiment of the invention, shown in FIG. 3, a movable guide 200, also used as a tensioner lever, comprises a synthetic resin shoe 210 having a front surface on which a transmission chain, belt or the like slides, and a reinforcing base 220, engaged with a rear surface of the shoe 210 along the longitudinal direction of the guide. A buffer material composed of a rubber sheet fills a gap S between the synthetic resin shoe 210 and the reinforcing base 220.

The guide 200 is comparatively thin, and the shoe 210 includes L-shaped side holding portions 211, disposed in alternating arrangement on opposite sides of the shoe along the longitudinal direction, for locking the shoe onto the reinforcing base 220. A U-shaped hook portion 212 is provided at the tip of the shoe. Even if the accuracy of the size of the shoe 210 including its L-shaped side holding portions 211 and U-shaped tip hook 212, cannot be maintained reliably due to cooling rate variations or thermal shrinkage in the molding process, since the rubber sheet buffer material 230 fills the gap S, wobbling in H direction shown in FIG. 3, between the shoe 210 and the base 220 can be avoided. As a result, impact noises can be suppressed. At the same time, since the tolerance range for molding accuracy is increased, even an inexpensive synthetic resin material, which is liable to cool unevenly and undergo significant thermal shrinkage, can be used. Consequently significant improvements in production efficiency and significant reductions in production costs can be realized.

The advantages of the invention can be summarized as follows.

The guide can apply appropriate tension to a traveling transmission medium such as a chain, belt or the like, and suppress vibration both in, and transverse to, the plane of travel of the medium, to ensure stable travel of the medium. Moreover, the buffer material filling the gaps between a slot and a reinforcing plate, or between a synthetic resin shoe and reinforcing base, solves the problem of wobbling and suppresses impact noises. And at the same time, since the tolerance range for molding accuracy is increased, and an inexpensive synthetic resin material, which is liable to cool unevenly and subject to significant thermal shrinkage, can be used. Accordingly, improved production efficiency and low production cost can be realized.

1. A elongated sliding contact guide for a transmission device, comprising:
a guide body including a shoe extending in the longitudinal direction of the guide, said shoe having on one side thereof a surface for sliding contact with a flexible, traveling power transmitting medium, and, on a side thereof opposite said one side, a plate-receiving portion also extending along the longitudinal direction of the guide, said plate-receiving portion having a slot extending along said longitudinal direction, said slot being defined by interior walls, and opening in a direction away from said shoe, said shoe and said plate-receiving portion being integrally molded as a unit from a synthetic resin, and
a reinforcing plate fitting into said slot;
there being a gap between the reinforcing plate and an interior wall of the slot;
wherein the improvement comprises a buffer material filling said gap.

2. A elongated sliding contact guide according to claim 1, in which there are plural gaps between said reinforcing plate and interior walls of the slot, and each said gap is filled with a buffer material.

3. An elongated sliding contact guide for a transmission device, comprising:
a synthetic resin shoe having on one side thereof a surface for sliding contact with a flexible, traveling, power transmitting medium; and
a reinforcing base disposed on a side of said synthetic resin shoe opposite to said one side thereof, and extending along the longitudinal direction of the guide, said shoe being connected to, and supported by said reinforcing base;
there being a gap between the shoe and the reinforcing base;
wherein the improvement comprises a buffer material filling said gap.
